(19) United States
(12) Patent Application Publication
(10) Pub. No.: US 2009/0163686 A1
(43) Pub. Date: Jun. 25, 2009

(54) METHOD OF MAKING AN INTRINSIC POLARIZER

(75) Inventors: Michael K. Gerlach, Saint Paul, MN (US); Gerald N. Nkwantah, Brockton, MA (US); Giorgio B. Trapani, Cambridge, MA (US); Pradnya V. Nagarkar, Weston, MA (US); Phillip J. Ralli, Sudbury, MA (US)

Correspondence Address: OLIFF & BERRIDGE, PLC, P.O. BOX 320850, ALEXANDRIA, VA, 22320-4850, US

(73) Assignee: 3M Innovative Properties Company

(21) Appl. No.: 11/960,775

(22) Filed: Dec. 20, 2007

(51) Int. Cl. B29D 7/01; C08F 10/00

(52) U.S. Cl. 526/348.1; 264/1.34

(57) ABSTRACT

An integrated wet stretch method of making an intrinsic polarizer includes the following steps in order: providing a polymeric film comprising poly(vinyl alcohol) and having an original length; immersing the polymeric film in a first bath comprising a first solution having a pH of less than about 3; uniaxially stretching the first polymeric film in the machine direction thereby forming a stretched polymeric film; removing the stretched polymeric film from the first bath; removing excess first solution from the stretched polymeric film; and uniaxially stretching the stretched polymeric film in the machine direction, at a temperature of at least about 120° C., thereby forming a further stretched polymeric film.

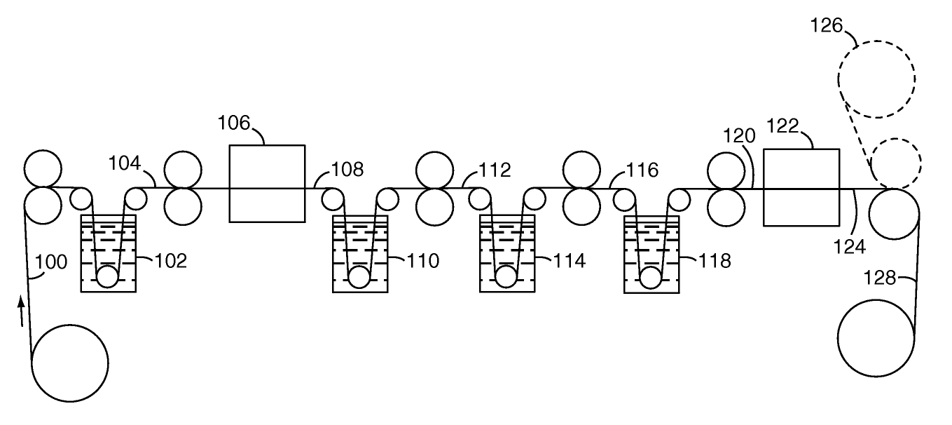

### FIELD OF THE INVENTION

This disclosure relates to a method of making an intrinsic polarizer, particularly an intrinsic polarizer comprising vinylene segments.

### BACKGROUND

Linear light polarizers, in general, owe their properties of selectively passing radiation vibrating along a given electromagnetic radiation vector, and absorbing electromagnetic radiation vibrating along a second given electromagnetic radiation vector, to the anisotropic character of the polarizer. Dichroic polarizers are absorptive, linear polarizers having a vectoral anisotropy in the absorption of incident light. The term “dichroism” as used herein refers to the property of differential absorption and transmission of the components of an incident beam of light depending on the direction of vibration of the components. Generally, a dichroic polarizer will transmit radiant energy along one electromagnetic vector and absorb energy along a perpendicular electromagnetic vector. A beam of incident light, on entering a dichroic polarizer, encounters two different absorption coefficients, one low and one high, so that the emergent light vibrates substantially in the direction of low absorption (high transmission).

Examples of synthetic dichroic polarizers are intrinsic polarizers, e.g., a polyvinylene-based polarizer such as a K-type polarizer. An intrinsic polarizer derives its dichroism from the light-absorbing properties of its matrix, rather than from the light-absorbing properties of dye additives, stains, or suspended crystalline material. Typically, intrinsic polarizers comprise a sheet or film of oriented poly(vinyl alcohol) in which a percentage of the poly(vinyl alcohol) has been dehydrated to form sequences of conjugated double bonds, i.e., polyvinylene. Intrinsic polarizers of this kind are typically formed by heating the polymeric film in the presence of an acidic vapor dehydration catalyst, such as vapors of hydrochloric acid, to produce conjugated polyvinylenes and unidirectionally stretching the polymeric film prior to, subsequent to, or during the dehydration step to align the poly(vinyl alcohol) matrix. By orienting the poly(vinyl alcohol) matrix unidirectionally, the transition moments of the conjugated polyvinylenes or chromophores are also oriented, and the material becomes visibly dichroic. A second orientation step or extension step and a boration treatment may be employed after the dehydration step. An improved K-type polarizer is known as a KE-type polarizer and has improved stability under various conditions such as high temperature.

### SUMMARY

Disclosed herein is a method of making an intrinsic polarizer, comprising the following steps in order: providing a polymeric film comprising poly(vinyl alcohol) and having an original length; immersing the polymeric film in a first bath comprising a first solution having a pH of less than about 3; uniaxially stretching the first polymeric film in the machine direction thereby forming a stretched polymeric film; removing the stretched polymeric film from the first bath; removing excess first solution from the stretched polymeric film; and uniaxially stretching the stretched polymeric film in the machine direction, at a temperature of at least about 120° C., thereby forming a further stretched polymeric film.

The method may further comprise the following steps in order: immersing the further stretched polymeric film in a second bath comprising a second solution, the second solution comprising borates and having a pH of less than about 7; removing excess second solution from the further stretched polymeric film; immersing the further stretched polymeric film in a third bath comprising a third solution, the third solution comprising borates and having a pH of less than about 7; removing excess third solution from the further stretched polymeric film; immersing the further stretched polymeric film in a fourth bath comprising a fourth solution, the fourth solution comprising borates and having a pH of less than about 7; and removing excess fourth solution from the further stretched polymeric film thereby forming a borate-treated polymeric film.

These and other aspects of the invention are described in the detailed description below. In no event should the above summary be construed as a limitation on the claimed subject matter which is defined solely by the claims as set forth herein.

### BRIEF DESCRIPTION OF DRAWINGS

The invention may be more completely understood in consideration of the following detailed description in connection with the following FIGURE:

The FIGURE shows a process flow diagram for the method disclosed herein.

### DETAILED DESCRIPTION

Disclosed herein is an integrated, single machine process for manufacturing an intrinsic polarizer. Typical processes for manufacturing KE polarizers require three different machine processing steps. An integrated manufacturing process is desirable so that the resulting product can be cost competitive with other polarizer film technologies.

In a typical three-step manufacturing process, a first step involved dry-stretching of PVA film in the machine direction over a narrow gap to orient the chains of the PVA. Once oriented, the film was extremely fragile. In order to further process the film without breaking, the film was then immediately laminated to a temporary polyester carrier film with a water-soluble PVA adhesive. After lamination to the carrier film, the stretched and laminated film was wound onto a core. The rolls of film were then aged for a minimum of three days before processing on the next machine. This step was necessary to minimize transmittance non-uniformity of the polarizer. The transmittance non-uniformity was due to moisture variations in the film resulting from a non-uniform adhesive coating.

At a second machine of the second step, the film was then passed over a bath of fuming hydrochloric acid where the vapors of hydrochloric acid were absorbed in the PVA film. Once absorbed in the film, the material then passed into a convection oven where the PVA was molecularly dehydrated to form the polyvinylene chromophore. After the formation of chromophore, the film was then wound onto another core.

Rolls of material from the second machine were then processed on the third machine in a third step. At the third machine, the PVA film laminated to the PET carrier was passed through a warm bath of water. This process step plasticized the PVA film and softened the water-soluble PVA adhesive that was used to laminate the PVA to PET on the first machine. Once the PVA was imbibed with water, its mechanical properties allowed the film to be handled without a carrier film and the carrier film was then stripped away from the PVA. After being stripped from the PVA, the film then passed through a series of boration tanks were the film was allowed to relax and neck-in. Similar to the wet-strech, integrated process, this improved the neutrality of the polarizer. After boration, the film was then washed to remove any salts on the surface of the film and dried. Once dried, the film could then be laminated to a substrate.

The method disclosed herein may be referred to as an integrated wet stretch process. The integrated wet stretch process may have a number of advantages as compared to the three-step process. For example, a six-day process from start-to-finish may be replaced with a process that takes less than thirty minutes.

Another example is that the wet stretch process may be a path suitable for commercialization because it facilitates higher stretch ratios of the PVA film. A key process handle to ensure the final KE polarizer has high contrast and high brightness is to have maximum alignment of the PVA chains at the time of conversion. While stretch ratios of greater than 6.5 times were demonstrated with the dry-stretch process, yields were quite low due to web breaks. The wet-stretch process allows for processing at stretch ratios in excess of 6.5 times with high yields. Web breaks with the integrated wet stretch process were eliminated because the film was allowed to neck-in in the transverse direction during the stretch process, resulting in a thicker, more durable film. In addition, the film was plasticized with water, minimizing brittle fracture.

The integrated wet stretch process may also be advantageous because it eliminates the need for a temporary polyester carrier film. This reduces the raw material cost in manufacturing the process, and eliminates disposal costs of the temporary film. In addition, it eliminates the water-based adhesive, a source of transmittance non-uniformities.

The integrated wet stretch process may also be advantageous because it replaces a tank of fuming 20° Baume hydrochloric acid with a hydrochloric acid solution with a concentration on the order of 0.01N. This is a significant environmental, health, and safety improvement. In addition, it reduces the cost of maintenance because of acid corrosion. In addition, the coating and imbibing of the film with hydrochloric acid may result in a more uniform polarizer transmittance. The fuming process may be susceptible to any changes in air currents over or near the fuming tank. The integrated wet stretch process creates an easy manufacturing path for the use of alternate, non-fuming acids, such as phosphoric or sulfuric acid.

The integrated wet stretch process may also be advantageous because a wider range of conversion temperatures can be used because the process is not limited by the temperature limitations of the temporary carrier film or the adhesive, which must retain its low peel strength. Having a wider temperature range of conversion enables the manufacture of a polarizer with more neutral transmittance. The lack of a substrate and temporary adhesive is also more amenable to alternate heating methods, such as infrared instead of convection, whose non-uniform air currents can result in non-uniformities.

The integrated wet stretch process may also be advantageous because it reduces yield losses. For example, two winding, unwinding, and start-up steps may be eliminated. In addition, web-in-process holding steps eliminate the opportunity of building inventory of intermediates that result in out-of-spec products. Further, because of the unique chemical processing of the polarizer, splices can not typically be run through the third machine. This limits the amount of material that can be made without stopping the machine to approximately 3000 linear feet. With the integrated process, approximately 20,000 lnft of material can be made without stopping the machine for splicing. This significantly reduces the amount of material lost to start-up and shut-down routines.

The method of making an intrinsic polarizer includes providing a polymeric film comprising poly(vinyl alcohol) (PVA). The raw material film of PVA can, in general, have a degree of polymerization of from about 2000 to about 3000, preferably about 2400. This is desirable because if the degree of polymerization is too low then the orientation that can be obtained is limited and if the degree of polymerization is too high then the process of swelling and orientation of the PVA becomes more difficult and less economically advantageous. The PVA film also has a degree of hydrolysis of at least about 99% so that the PVA film can be easily swelled without dissolving. The raw material film can have a thickness of between about 10 um and 100 um, preferably about 75 um. Further, the raw material film is desirably plasticized with a plasticizer such as glycerin, so that the initial orientation can be carried out at a lower temperature. Useful amounts of plasticizer can be from about 10 to about 15 wt. %. A useful commercially available poly(vinyl alcohol) film is VF-PS grade from Kuraray of Japan. VF-PS grade PVA film is plasticized with about 12% glycerin. The film can be drum cast to a width of 2.6 m and slit to provide a 1.3 m roll.

The FIGURE shows a process flow diagram for the integrated wet stretch process. A 65 cm wide PVA film 100 is unwound and submerged into a first bath 102 of a first solution having a pH of less than about 3. Typically, this first solution comprises a strong acid selected from the group consisting of HCl, H₂SO₄, H₃PO₄, HBr, HI, and a combination thereof. Typically, the first bath has a normality of from about 0.008 to about 0.02 and is at a temperature of from about 35 to about 42° C., for example, about 38° C. In some embodiments, if a high-contrast, high-brightness polarizer is desired, the target concentration of the first solution is from about 0.012 to about 0.013 N, for example, about 0.0128 N. To increase the transmittance of the polarizer, the concentration of HCl can be reduced. If a darker polarizer is desired, the concentration of HCl can be increased.

While immersed in the first bath, glycerin and surfactant from the film may be removed and acid and water from the first bath may be absorbed. The incoming nip speed to this process step may be around 0.23 m/minute, while the output nip speed to this may be around 0.91 m/minute. The temperature of the first bath and dwell time may be critical to ensure uniform absorption of the first solution and maximum alignment or orientation of the PVA chains. The submerged path length may be around 1.7 m, targeting a film tension in this draw zone of around 200 N. At the exit of the first bath, the film then passes through a nip which not only controls the amount of draw, but also removes excess first solution from the film.

While immersed in the first bath, the film is uniaxially stretched in the machine direction to form a stretched polymeric film. The amount of stretch can be varied so that the original length of the film increases from about 3.5 to about 4.5 times. For example, the film can be stretched so that it is about 4.0 times the original length. The degree of orientation which is imparted to the PVA film prior to the dehydration step is important in determining the distribution of conjugation lengths that will be generated. It has been found that this initial orientation is especially suited for high efficiency visible applications.

The stretched polymeric film 104 is then uniaxially stretched in the machine direction, thereby forming a further stretched polymeric film 108. The further stretched polymeric film has a length of from about 7.0 to about 8.5 times the original length, for example, an additional 1.88 times, for a total stretch of 7.5 times. The additional stretch at this stage of manufacture is a good compromise for good chromophore orientation and ease of web handling.

During this second stretching step, the film is molecularly dehydrated by heating the web in a bank of infrared heaters 106. The film can be heated from either one side, or two; however, a more uniform sheet can be manufactured when uniformly heated from both sides of the film. The lamps used may be Protherm FS series medium wavelength infrared heaters from Process Thermal Dynamics of Brandon, Minn. A heated span of about 0.36 m may be used, with the IR filament about 0.20 m from the web face. The temperature of the filament may be controlled to at least about 600° C., typically around 1075° C. The film temperature is at least about 125° C., for example, at least about 200° C. A film tension at this point may be around 330 N. As the web exits from under the IR lamps, its width is approximately 0.27 m. At this point in the process, the film is now a polarizer with a dark maroon-to-brown appearance. The IR lamps can be enclosed to minimize air movement around the conversion zone. Any disruption in the air flow patterns around the film can upset the conversion process. In addition, the enclosure acts as a shroud to prevent fugitive vapors from subsequent processing tanks from entering the conversion zone.

As the web exits from the IR enclosure, the film is immediately immersed in a second bath 110 comprising a second solution, the second solution comprising borates and having a pH of less than about 7. In particular, the second solution may comprise from about 4 to about 10% boric acid and from about 1 to about 4.5% borax decahydrate. The second solution may be at a temperature of from about 85 to about 96° C., for example, about 93° C. Because the web exiting the IR zone is highly oriented and very dry, the purpose of this swell is to begin to imbibe the film with water, which is a plasticizer of PVA. In addition, the water is highly effective at controlling static. Without this submersion step, the web may shred apart when passed through a nip. The web path through this tank is about 0.6 m. After swelling the film, it is then passed through a nip which is used to control the stretch of the film under the IR heaters. Excess second solution is removed from the film.

The film 112 is then submerged into a third bath 114 comprising a third solution, the third solution comprising borates and having a pH of less than about 7, for example, about 3.5. The third solution may comprise from about 4 to about 10% boric acid and from about 1 to about 4.5% borax decahydrate. The third solution may be at a temperature of from about 87 to about 93° C., for example, about 90° C. The third bath may comprise a tray approximately 1.8 m in length. In the third bath, the film may be relaxed from about 5 to about 15%, for example, about 10%, allowing the film to swell with the borate solution. As the film swells with the fluid, it expands significantly in width. The tank temperature and the stretch ratio in the third bath can be optimized to keep the increase in film width from about 5 to about 15%, for example, about 10%, for an absolute width of about 0.3 m. The film tension in this tank may be approximately 70 N. At the exit of the third bath, the web passes through a nip which is used to control the stretch ratio in the tray. This removes excess third solution from the further stretched polymeric film.

The film 116 is then submerged into a fourth bath 118 comprising a fourth solution, the fourth solution comprising borates and having a pH of less than about 7, for example, about 3.5. The fourth solution may comprise from about 4 to about 10% boric acid and from about 1 to about 4.5% borax decahydrate. The fourth solution may be at a temperature of from about 89 to about 95° C., for example, about 92° C. The fourth bath may comprise a tray approximately 1.8 m in length. The stretch ratio in the fourth tank may be maintained at 1.0×; however, due to the additional time at temperature in this solution, the film can undergo a chemical reaction with the boric acid whereby the pass-state transmittance of the film increases significantly and the film develops a neutral gray appearance. During the chemical reaction of boration in the fourth bath, the film increases in width by about an additional about 5 to about 25, for example, about 20%, for an absolute width of about 0.35 m. Because of this significant expansion in width, the web must be stretched using an edge puller system before contacting any idlers or nips to eliminate wrinkles. After the edge puller system, the web is then passed through a nip which is used to control the stretch ratio in this boric acid tray. Excess fourth solution from the further stretched polymeric film. As described herein, the film may be referred to as a borate-treated polymeric film after this step.

The method may further comprise washing the borate-treated polymeric film with de-ionized water at a temperature of from about 5 to about 15° C., for example, at a temperature of about 10° C. The web path through the de-ionized water may be about 0.2 m. Washing is used to mechanically remove any boric acid that may still be remaining on the web surface. During this process step the web is stretched approximately 1.04 times.

After exiting the wash step, the web 120 passes through a convection dryer 122, where the temperature of the heated air at the film may be from about 70 to about 90° C., for example, about 85° C. The volumetric flow rate of air is about 50 cubic feet per minute with air velocities at the impingement slots of about 120 feet per minute. The oven span is about 2.5 m in length. While the film is dried, the web is stretched about 1.04 times to maintain a tension of about 80 N. This additional stretch helps to maintain and fix the alignment of the polyvinylene chains within the film. As the web exits the dryer, its width is about 0.25 m. The film thickness is in the range of 20-25 um. Once dried, the film 124 can be laminated to a variety of optical films or temporary carrier films 126 to give laminate 128.

What is claimed is:

1. A method of making an intrinsic polarizer, comprising the following steps in order:
providing a polymeric film comprising poly(vinyl alcohol) and having an original length;
immersing the polymeric film in a first bath comprising a first solution having a pH of less than about 3;
uniaxially stretching the first polymeric film in the machine direction thereby forming a stretched polymeric film;
removing the stretched polymeric film from the first bath;
removing excess first solution from the stretched polymeric film; and
uniaxially stretching the stretched polymeric film in the machine direction, at a temperature of at least about 120° C., thereby forming a further stretched polymeric film.

2. The method of claim 1, further comprising the following steps in order:
immersing the further stretched polymeric film in a second bath comprising a second solution, the second solution comprising borates and having a pH of less than about 7;
removing excess second solution from the further stretched polymeric film;
immersing the further stretched polymeric film in a third bath comprising a third solution, the third solution comprising borates and having a pH of less than about 7;
removing excess third solution from the further stretched polymeric film;
immersing the further stretched polymeric film in a fourth bath comprising a fourth solution, the fourth solution comprising borates and having a pH of less than about 7; and
removing excess fourth solution from the further stretched polymeric film thereby forming a borate-treated polymeric film.

3. The method of claim 2, further comprising the following steps in order:
washing the borate-treated polymeric film with water at a temperature of from about 5 to about 15° C.; and
drying the borate-treated polymeric film with air at a temperature of about 70 to about 90° C.

4. The method of claim 1, wherein the poly(vinyl alcohol) has a degree of polymerization of from about 2000 to about 3000 and a degree of hydrolysis of at least about 99%.

5. The method of claim 1, wherein the polymeric film comprises from about 10 to about 15 wt. % glycerin.

6. The method of claim 1, wherein the first bath has a normality of from about 0.008 to about 0.02 and is at a temperature of from about 35 to about 42° C.

7. The method of claim 1, wherein the first bath comprises a strong acid selected from the group consisting of HCl, H₂SO₄, H₃PO₄, HBr, HI, and a combination thereof.

8. The method of claim 1, wherein the stretched polymeric film has a length of from about 3.5 to about 4.5 times the original length.

9. The method of claim 1, wherein the further stretched polymeric film has a length of from about 7.0 to about 8.5 times the original length.

10. The method of claim 2, wherein the second solution comprises from about 4 to about 10% boric acid and is at a temperature of from about 85 to about 96° C.

11. The method of claim 2, wherein the second solution comprises from about 4 to about 10% boric acid and from about 1 to about 4.5% borax decahydrate.

12. The method of claim 2, wherein the third solution comprises from about 4 to about 10% boric acid and is at a temperature of from about 87 to about 93° C.

13. The method of claim 2, wherein the third solution comprises from about 4 to about 10% boric acid and from about 1 to about 4.5% borax decahydrate.

14. The method of claim 2, wherein the width of the further stretched polymeric film increases from about 5 to about 15% in the third bath.

15. The method of claim 2, wherein the fourth solution comprises from about 4 to about 10% boric acid and is at a temperature of from about 89 to about 95° C.

16. The method of claim 2, wherein the fourth solution comprises from about 4 to about 10% boric acid and from about 1 to about 4.5% borax decahydrate.

17. The method of claim 2, wherein the width of the further stretched polymeric film increases from about 5% to about 25% in the fourth bath.

18. An intrinsic polarizer formed by the method of claim 1.

19. An intrinsic polarizer formed by the method of claim 2.

20. An intrinsic polarizer formed by the method of claim 3.
